(19) United States
(12) Patent Application Publication
(10) Pub. No.: US 2017/0357999 A1
(43) Pub. Date: Dec. 14, 2017

(54) METHOD AND SYSTEM FOR PROVIDING RANKING INFORMATION USING EFFECT ANALYSIS DATA OF INFORMATION DATA

(71) Applicants: NHN Entertainment Corporation, Seongnam-si (KR); NHN AD CORPORATION, Seongnam-si (KR)

(72) Inventors: Insun SHIN, Seongnam-si (KR); Byeongjin SON, Seongnam-si (KR); Ji hye HWANG, Seongnam-si (KR)

(21) Appl. No.: 15/616,234

(22) Filed: Jun. 7, 2017

(30) Foreign Application Priority Data
Jun. 9, 2016 (KR) 10-2016-0071621

(51) Int. Cl. G06Q 30/02

(52) U.S. Cl. CPC G06Q 30/0243; G06Q 30/0273; G06Q 30/0246

(57) ABSTRACT

A method of ranking information of content automatically generated in response to a service request of a user includes: analyzing an effect of providing the content based on at least one analysis index; generating ranking information about at least one item associated with the content provided based on the effect analysis result; and providing the ranking information about the at least one item in response to receiving a service request from an electronic device operated by the user.

### CROSS-REFERENCE TO RELATED APPLICATION

This application claims priority from and the benefit of Korean Patent Application No. 10-2016-0071621, filed on Jun. 9, 2016, which is hereby incorporated by reference for all purposes as if fully set forth herein.

### BACKGROUND OF THE INVENTION

### Field of the Invention

Exemplary embodiments relate to technology for providing a variety of ranking information for an advertising operation.

### Description of Related Art

With the popularization of the Internet, distribution and sales of goods and services using Internet shopping malls are being actively conducted. Currently, the opportunities for mobile business using a smartphone and the like are being expanded and the mobile shopping market is also rapidly increasing.

For example, Korean Patent Registration No. 10-0460008, registered on Nov. 25, 2004, discloses an online shopping search service providing a method and system that may construct a database configured to systematically store information about sellers, and that may perform a series of processes associated with an online shopping search service using the database.

The above information disclosed in this Background section is only for enhancement of understanding of the background of the inventive concepts, and, therefore, it may contain information that does not form the prior art that is already known to a person of ordinary skill in the art.

### SUMMARY OF THE INVENTION

Exemplary embodiments provide a method and system that may provide an advertiser with various and objective ranking information for an advertising operation.

Exemplary embodiments also provide a method and system that may provide an advertiser with a solution appropriate for an advertising operation.

Additional features of the invention will be set forth in the description which follows, and in part will be apparent from the description, or may be learned by practice of the invention.

Exemplary embodiments disclose a method of providing a ranking information of content automatically generated in response to a service request of a user, the method including: analyzing an effect of providing the content based on at least one analysis index; generating ranking information about at least one item associated with the content provided based on the effect analysis result; and providing the ranking information about the at least one item in response to receiving a service request from an electronic device operated by the user.

The generating of ranking information may include calculating a ranking of a corresponding item based on an effect analysis result of a corresponding index with respect to each analysis index.

The generating of ranking information may include calculating a ranking of a corresponding item based on an average effect analysis result of analysis indices with respect to each item.

The generating of ranking information may include calculating a ranking of a corresponding item based on a ratio of the item to a total of effect analysis results of analysis indices with respect to each item.

The generating of ranking information may include generating the ranking information for each of at least one item of a advertising format, a device, a type, a medium, a type of business, cost, and a keyword that are associated with displaying of the content based on the effect analysis result.

The analyzing of the effect may include collecting and aggregating effect analysis data corresponding to providing of the content through an external server or medium

The providing of the ranking information may include providing ranking information of an item corresponding to a search condition in response to receiving the search condition from the electronic device.

The providing of the ranking information may include providing ranking information of a keyword or ranking information of an item corresponding to the keyword in response to receiving an input of the keyword as a search condition from the electronic device.

The method may further include registering a specific item as a target of interest associated with a user of the electronic device in response to a selection on the specific item among items included in the ranking information through the electronic device.

The method may further include providing at least one of items registered as the target of interest as an execution condition for providing content associated with the user.

Exemplary embodiments disclose a non-transitory computer-readable storage medium storing instructions that, when executed by a processor, cause the processor to perform a method of providing a ranking information of content automatically generated in response to a service request of a user, the method including: analyzing an effect of providing the content based on at least one analysis index; generating ranking information about at least one item associated with the content provided based on the effect analysis result; and providing the ranking information about the at least one item in response to receiving a service request from an electronic device operated by the user.

Exemplary embodiments disclose a ranking information providing system configured to automatically generate a ranking information of content in response to a service request of a user, the ranking information providing system including: an effect analyzer configured to analyze an effect corresponding to providing of content based on at least one analysis index; a ranking generator configured to generate ranking information about at least one item associated with providing of the content based on the effect analysis result; and a ranking provider configured to provide the ranking information about the at least one item in response to receiving a service request from an electronic device.

According to exemplary embodiments, it is possible to provide a wide selection of objective data for an advertising operation by providing ranking information about various items, for example, an index, an advertising format, a device, an advertising type, a medium, a type of business, a billing range, an user influx source, a keyword, and the like, based on effect analysis data about an advertising product.

Also, according to exemplary embodiments, it is possible to provide an advertising operation solution suitable and specified for an advertiser request by providing an advertiser with a search environment associated with an advertising product, a keyword, and the like, and by providing detailed effect analysis data and ranking information associated with a search target using the search environment.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a network environment according to exemplary embodiments.

FIG. 2 illustrates an electronic device and a server according to exemplary embodiments.

FIG. 3 illustrates components included in a processor of a server according to exemplary embodiments.

FIG. 4 illustrates a method performed at a server according to exemplary embodiments.

FIGS. 5, 6, 7, 8, 9, 10, and 11 illustrate a method of generating ranking information according to exemplary embodiments.

FIGS. 12, 13, and 14 illustrate a service screen for providing ranking information according to exemplary embodiments.

FIGS. 15 and 16 illustrate an advertising effect search screen according to exemplary embodiments.

### DETAILED DESCRIPTION OF THE ILLUSTRATED EMBODIMENTS

Exemplary embodiments will be described in detail with reference to the accompanying drawings. These exemplary embodiments will be described in detail for those skilled in the art in order to practice the present disclosure. It should be appreciated that various exemplary embodiments are different, but do not have to be exclusive. For example, specific shapes, configurations, and characteristics described in an exemplary embodiment may be implemented in another exemplary embodiment without departing from the spirit and the scope of the present disclosure. In addition, it should be understood that position and arrangement of individual components in each disclosed exemplary embodiment may be changed without departing from the spirit and the scope of the present disclosure. Therefore, a detailed description described below should not be construed as being restrictive. In addition, the scope of the present disclosure is defined only by the accompanying and their equivalents if appropriate. Similar reference numerals will be used to describe the same or similar functions throughout the accompanying drawings. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

The terminology used herein is for the purpose of describing exemplary embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements and/or components, but do not preclude the presence or addition of one or more other features, integers, steps, operations, elements, components, and/or groups thereof.

Hereinafter, exemplary embodiments are described in detail with reference to the accompanying drawings.

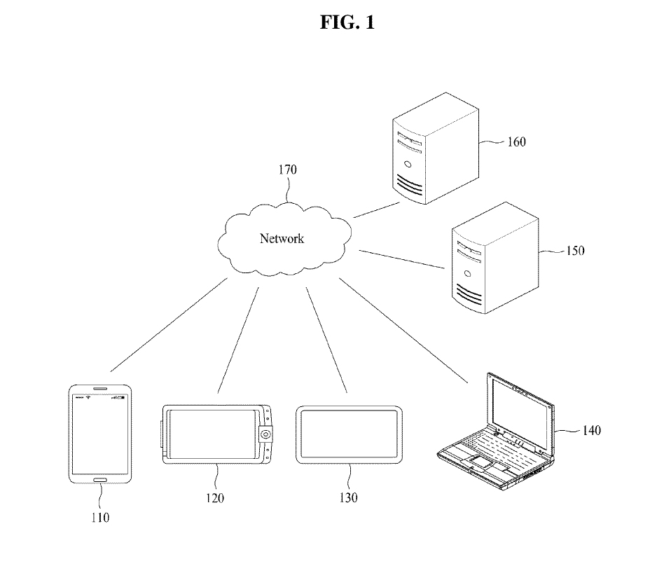

FIG. 1 is a diagram illustrating a network environment according to exemplary embodiments. Referring to FIG. 1, the network environment includes a plurality of electronic devices 110, 120, 130, and 140, a plurality of servers 150 and 160, and a network 170. FIG. 1 is provided as an example only and thus, a number of electronic devices and/or a number of servers are not limited thereto.

Each of the plurality of electronic devices 110, 120, 130, and 140 may be a fixed terminal or a mobile terminal configured as a computer device. For example, the plurality of electronic devices 110, 120, 130, and 140 may be a smartphone, a mobile phone, navigation, a computer, a laptop computer, a digital broadcasting terminal, a personal digital assistant (PDA), a portable multimedia player (PMP), a tablet personal computer (PC), and the like. For example, the electronic device 110 may communicate with other electronic devices 120, 130, and/or 140, and/or the servers 150 and/or 160 over the network 170 in a wired communication manner or in a wireless communication manner.

The communication scheme is not particularly limited and may include a communication method that uses a near field communication between devices as well as a communication method using a communication network, for example, a mobile communication network, the wired Internet, the wireless Internet, and a broadcasting network, which may be included in the network 170. For example, the network 170 may include at least one of network topologies that include networks, for example, a personal area network (PAN), a local area network (LAN), a campus area network (CAN), a metropolitan area network (MAN), a wide area network (WAN), a broadband network (BBN), the Internet, and the like. Also, the network 170 may include at least one of network topologies that include a bus network, a star network, a ring network, a mesh network, a star-bus network, a tree or hierarchical network, and the like. However, it is only an example and the exemplary embodiments are not limited thereto.

Each of the servers 150 and 160 may be configured as a computer apparatus or a plurality of computer apparatuses that provides instructions, codes, files, contents, services, and the like through communication with the plurality of electronic devices 110, 120, 130, and/or 140 over the network 170.

For example, the server 160 may provide a file for installing an application to the electronic device 110 connected over the network 170. In this case, the electronic device 110 may install the application using the file provided from the server 160. Also, the server 160 may connect to the server 150 and may receive a service or content provided from the server 150 under control of at least one program, for example, a browser or the installed application, and an OS included in the electronic device 110. For example, in response to a service request message that is transmitted from the electronic device 110 to the server 150 over the network 170 under control of the application, the server 150 may transmit a code corresponding to the service request message to the electronic device 110. The electronic device 110 may provide the content to the user by configuring and displaying a screen corresponding to the code under control of the application.

The server 150 may serve as an advertising platform. The advertising platform may refer to a system configured to bid for content that is provided as information data of an advertiser, match between targeting elements for a user to which the content is to be provided, to align contents, charge the advertiser for providing and displaying the content using a publisher, and the like. Here, the publisher may refer to a medium for displaying contents. The publisher may provide a path through which the user may directly receive the content. In a general online environment, contents may be displayed through a website/mobile site.

Herein, the server 150 may serve as a platform to provide the advertiser with a variety of ranking information for an advertising operation based on effect analysis data corresponding to providing the content. The platform to provide ranking information based on advertising effect analysis may be configured to be included in an advertising platform or may be configured as a system separate from the advertising platform and to interact.

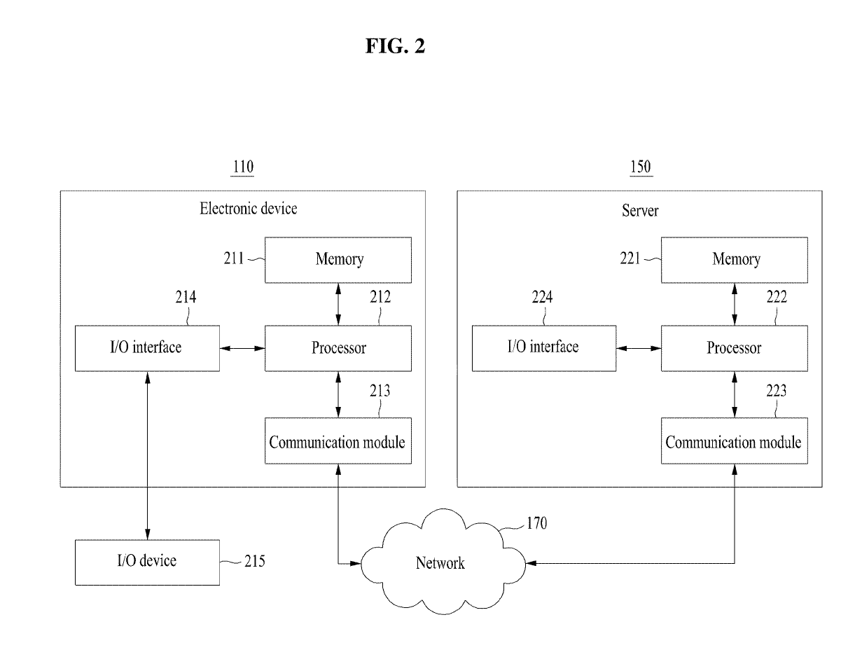

FIG. 2 is a block diagram illustrating a configuration of an electronic device and a server according to exemplary embodiments. FIG. 2 illustrates an exemplary configuration of the electronic device 110 and an exemplary configuration of the server 150. The same or similar components may be applicable to other electronic devices 120, 130, and/or 140, or the server 160, and also to still other electronic devices or still other servers.

Referring to FIG. 2, the electronic device 110 may include a memory 211, a processor 212, a communication module 213, and an input/output (I/O) interface 214, and the server 150 may include a memory 221, a processor 222, a communication module 223, and an I/O interface 224. The memory 211 and 221 may include a permanent mass storage device, such as random access memory (RAM), read only memory (ROM), a disk drive, etc., as a computer-readable storage medium. Also, an OS and at least one program code, for example, a code for an application for a video call, a browser, etc., installed and executed on the electronic device 110, may be stored in the memory 211 and 221. Such software components may be loaded from another computer-readable storage medium separate from the memory 211 and 221 using a drive mechanism. The other computer-readable storage medium may include, for example, a floppy drive, a disk, a tape, a DVD/CD-ROM drive, a memory card, etc. According to other exemplary embodiments, software components may be loaded to the memory 211 and 221 through the communication module 213 and 223, instead of, or in addition to, the computer-readable storage medium. For example, at least one program may be loaded to the memory 211 and 221 based on a program, for example, the application, installed by files provided over the network 170 from developers or a file distribution system, for example, the server 160, which provides an installation file of the application.

The processor 212 and 222 may be configured to process computer-readable instructions of a computer program by performing basic arithmetic operations, logic operations, and I/O operations. The computer-readable instructions may be provided from the memory 211 and 221 and/or the communication module 213 and 223 to the processor 212 and 222. For example, the processor 212 and 222 may be configured to execute received instructions in response to the program code stored in the storage device, such as the memory 211 and 221.

The communication module 213 and 223 may provide a function for communication between the electronic device 110 and the server 150 over the network 170, and may provide a function for communication with another electronic device, for example, the electronic device 120 or another server, for example, the server 160. For example, the processor 212 of the electronic device 110 may transfer a request, for example, a request for a video call service, created based on a program code stored in the storage device such as the memory 211, to the server 150 over the network 170 under control of the communication module 213. Inversely, a control signal, an instruction, content, a file, etc., provided under control of the processor 222 of the server 150 may be received at the electronic device 110 through the communication module 213 of the electronic device 110 by going through the communication module 223 and the network 170. For example, a control signal, an instruction, etc., of the server 150 received through the communication module 213 may be transferred to the processor 212 or the memory 211, and content, a file, etc., may be stored in a storage medium further includable in the electronic device 110.

The I/O interface 214 and 224 may be a device used for interface with an I/O device 215. For example, an input device may include a keyboard, a mouse, etc., and an output device may include a device, such as a display for displaying a communication session of an application. As another example, the I/O interface 214 may be a device for interface with an apparatus in which an input function and an output function are integrated into a single function, such as a touch screen. In detail, when processing instructions of the computer program loaded to the memory 211, the processor 212 of the electronic device 110 may display a service screen configured using data provided from the server 150 or the electronic device 120, or may display content on a display through the I/O interface 214.

According exemplary embodiments, the electronic device 110 and the server 150 may include a greater or lesser number of components than the number of components shown in FIG. 2. However, many components may also be included according to the related art. For example, the electronic device 110 may include at least a portion of the I/O device 215, or may further include other components, for example, a transceiver, a global positioning system (GPS) module, a camera, a variety of sensors, a database, and the like. In detail, if the electronic device 110 is a smartphone, the electronic device 110 may be configured to further include a variety of components, for example, an accelerometer sensor, a gyro sensor, a camera, various physical buttons, a button using a touch panel, an I/O port, a vibrator for vibration, etc., which are generally included in the smartphone.

Exemplary embodiments relate to technology for providing a variety of ranking information for an advertising operation. Hereinafter, exemplary embodiments of a method and system for providing ranking information about various items with respect to an advertising effect are described.

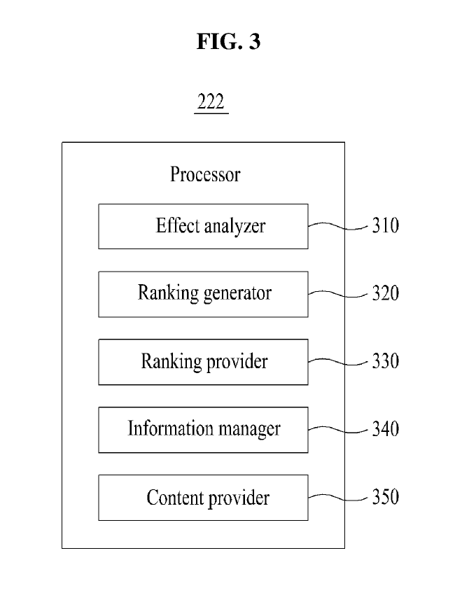

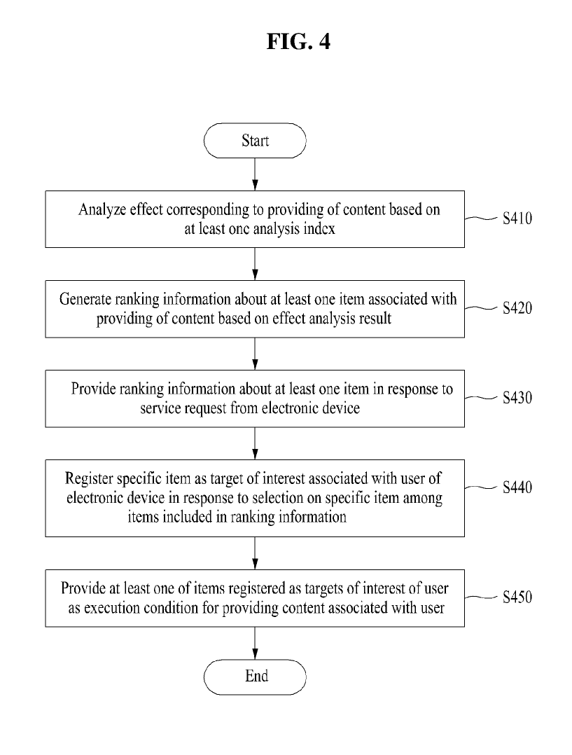

FIG. 3 illustrates components included in a processor of a server according to exemplary embodiments, and FIG. 4 is a flowchart illustrating a method performed at a server according to exemplary embodiments.

Referring to FIG. 3, the processor 222 of the server 150 may include, as components, an effect analyzer 310, a ranking generator 320, a ranking provider 330, an information manager 340, and a content provider 350. The processor 222 and the components of the processor 222 may be configured to control the server 150 to perform operations S410 through S450 included in the method of FIG. 4. Here, the processor 222 and the components of the processor 222 may be configured to execute instructions according to a code of at least one program and a code of the OS included in the memory 221. Also, the components of the processor 222 may be representations of different functions of the processor 222 performed by the processor 222 in response to a control instruction provided from the OS or the at least one program. For example, the effect analyzer 310 may be used as a functional representation of the processor 222 that analyzes an effect corresponding to providing of the content in response to the control instruction.

In operation S410, an effect analyzer 310 may analyze an effect corresponding to providing of the content based on at least one analysis index. The at least one analysis index may inclusively indicate any of indices that represent the advertising efficiency of a content of an advertiser. The at least one analysis index may include, for example, a click through ratio (CTR), click cost, a conversion rate, conversion cost, return on ads spending (ROAS), a number of executions, a number of displays, a number of clicks, a number of conversions, cost per click (CPC), cost per Install (CPI), cost per action (CPA), cost per engagement (CPE), cost per view (CPV), a proportion of a number of user influxes, a proportion of a number of conversions, a proportion of a number of direct conversions, a proportion of a number of indirect conversions, and the like. The effect analyzer 310 may collect and aggregate effect analysis data associated with an analysis index with respect to content. However, it is provided as an example only and the effect analyzer 310 may collect and aggregate effect analysis data about the content that is provided through an external medium or another server connectable with the server 150.

In operation S420, the ranking generator 320 may generate ranking information about at least one item associated with providing of the content based on the effect analysis result. Here, the item refers to an effect analysis target and may include a product on sales to provide the content with respect to the advertiser. That is, the at least one item may inclusively indicate any type of targets, for example, a medium, a path, a criterion, etc., used for providing the content. For example, the at least one item may include a content display medium, a content display material or type, a content display device, a source (medium) or a type of business associated with content flow, a keyword, advertising cost of content, and the like. For example, the ranking generator 320 may calculate a ranking of a corresponding item that is an effect analysis target, based on an effect analysis result of a corresponding index with respect to each analysis index. As another example, the ranking generator 320 may calculate a ranking of a sub-item included in a corresponding item based on the average effect analysis result of analysis indices with respect to each item that is an effect analysis target. That is, the ranking generator 320 may generate ranking information based on an average value acquired by averaging effect analysis data of all of the analysis indices. As another example, the ranking generator 320 may calculate a ranking of a sub-item included in a corresponding item as a proportion of the item to a total of effect analysis results of analysis indices with respect to each item that is an effect analysis target. That is, the ranking generator 320 may generate ranking information based on a ratio of a corresponding item to a total of effect analysis data of all of analysis indices.

In operation S430, the ranking provider 330 may provide ranking information about at least one item associated with providing of the content, in response to receiving a service request, for example, a site access request, a search request, etc., from an electronic device, for example, the electronic device 110. The ranking provider 330 may provide a user, for example, an advertiser, with a service for opening effect analysis data that is aggregated for providing of a large amount of contents and ranking information for each item that is an effect analysis target. Accordingly, the ranking provider 330 may provide a report, a trend, a solution, etc., for an advertising operation by collecting effect analysis data using various content display paths and methods and by providing various rankings. The ranking provider 330 may provide a search environment for the effect analysis result. For example, in response to receiving a search condition from the electronic device, the ranking provider 330 may provide ranking information of an item corresponding to the search condition. Accordingly, the user may refer to an advertising product that meets a desired search condition and may verify the advertising efficiency of the product. As another example, in response to receiving a keyword as a search condition from the electronic device, the ranking provider 330 may provide ranking information of the keyword or ranking information of an item corresponding to the keyword. In this manner, the user may search for a keyword that meets a desired search condition from among keywords used for advertising and may verify the advertising efficiency of the keyword. As described above, the ranking provider 330 may provide a search environment in which the user may select various search areas and search conditions, etc., and may verify the advertising efficiency.

In operation S440, the information manager 340 may register a specific item as a target of interest associated with the user of the electronic device in response to a selection on the specific item among items included in the ranking information through the electronic device. Once the user selects the specific item while using the service for opening ranking information for each item that is an effect analysis target, the information manager 340 may add the specific item as a target of interest of the user. Also, in a search environment for an effect analysis result, the information manager 340 may add, as the target of interest of the user, an item that is selected by the user from among items included in a search result. Accordingly, the user may refer to effect analysis reports and trends, etc., acquired using various content display paths and methods, and may select a product suitable for an advertising operation of the user and may manage the selected product as a product of interest.

In operation S450, the content provider 350 may provide at least one of items registered as targets of interest of the user as an execution condition for providing content associated with the user. An item included in the target of interest of the user may be used as a content display path or method by the user for an advertising operation. For example, the content provider 350 may directly display the content of the user through a medium associated with the server 150, and may display the content using an item included in the target of interest of the user. As another example, if the server 150 is not directly involved in the adverting operation of the user, the information manager 340 may transfer information about the target of interest of the user to an external medium or server through which the advertising operation of the user is performed, or may notify an external medium or server corresponding to the target of interest of the user about registration as the target of interest.

Hereinafter, exemplary embodiments, such as an effect analysis process and a ranking generation process, are described.

The analysis indices for advertising effect analysis may include a CTR, click cost, a conversion rate, conversion cost, ROAS, a number of executions, a number of displays, a number of clicks, a number of conversions, CPC, CPI, CPA, CPE, CPV, a proportion of a number of user influxes, a proportion of a number of conversions, a proportion of a number of direct conversions, a proportion of a number of indirect conversions, and the like.

The CTR may be defined as an index indicating a ratio of users that view a specific advertising product and click a corresponding advertising product, which may be represented by the following formula: CTR (%)=(number of clicks/number of displays)×100. For example, if 1,000 users view a specific product and 500 users click the product, the CTR is calculated as 0.5%.

The click cost may be defined as an index indicating the average cost that occurs per click with respect to an corresponding advertising, which may be represented by the following formula: click cost=advertising cost/number of clicks. For example, if a total of advertising cost of a specific product is 1 million Korean Won (KRW) and 5,000 users click the product, the click cost is calculated as 200 KRW.

The conversion rate may be defined as an index indicating a ratio of users that visit a site through a specific advertising product and then generate a conversion, such as a purchase, a membership signup, and the like, which may be represented by the following formula: conversion rate (%)={number of conversions/number of user influxes(number of clicks)}×100. For example, if 5,000 users click a specific product and 100 conversions occur, the conversion rate is calculated as 2%.

The conversion cost may be defined as an index indicating cost that occurs per single conversion, which may be represented by the following formula: conversion cost=advertising cost/number of conversions. For example, if a total of advertising cost of a specific product is 1 million KRW and 100 conversions occur, the conversion cost is calculated as 10,000 KRW.

The ROAS may be defined as an index indicating sales over advertising cost, which may be represented by the following formula: ROAS (%)=(sales/advertising cost)×100. For example, if a total of advertising cost of a specific product is 1 million KRW and sales of 10 million KRW occurs, the ROAS is calculated as 1,000%.

The number of executions may be defined as an index indicating a proportion of a number of advertisers that execute advertising, which may be represented by the following formula: number of executions (%)=(number of executions of specific product/total number of executions of all products)×100. For example, if a total number of advertisers is 1,000 and 500 advertisers execute a specific product, the number of executions (proportion) is calculated as 50%.

The number of displays may represent an index referring to a number of times that a specific product is displayed, the number of clicks may represent an index indicating a number of times that users click the specific product, and the number of conversions may represent an index indicating the number of conversions to a purchase, a membership signup, an application installation, and the like with respect to the specific product.

CPC, CPI, CPA, CPE, and CPV relate to advertising cost indices that are used to determine the advertising cost, and may represent a number of clicks on an advertising product, a number of installations of related software (a mobile application, etc.), a number of executions of related software, and a number of plays associated with a related moving picture, respectively.

The proportion of the number of user influxes is an index indicating the proportion of the number of users that are fluxed into a specific site. For example, if the number of user influxes of total sites is 1,000,000 and the number of user influxes of a site A is 500,000, the proportion of the number of user influxes of the site A is calculated as 50%.

The proportion of the number of conversions is an index indicating the proportion of the number of conversions, such as a purchase, a membership signup, etc., at a specific site. For example, if the number of conversions of total sites is 1,000,000 and 500,000 conversions occur at a site A, the proportion of the number of conversions of the site A is calculated as 50%.

The proportion of the number of direct conversions is an index indicating the proportion of the number of times (the number of direct conversions) that direct conversion occurs through an influx to a specific site. For example, if the number of direct conversions of total sites is 1,000,000 and 500,000 direct conversions occur at the site A, the proportion of the number of direct conversions of the site A is calculated as 50%.

The proportion of the number of indirect conversions is an index indicating the proportion of the number of times (the number of indirect conversions) that indirect conversion to another influx through an influx of a specific site occurs. For example, if the number of indirect conversions of total sites is 1,000,000 and 500,000 indirect conversions occur at the site A, the proportion of the number of indirect conversions of the site A is calculated as 50%.

The effect of an advertising product may be analyzed based on the aforementioned analysis indices and ranking information about various items associated with the advertising product may be generated based on the effect analysis result.

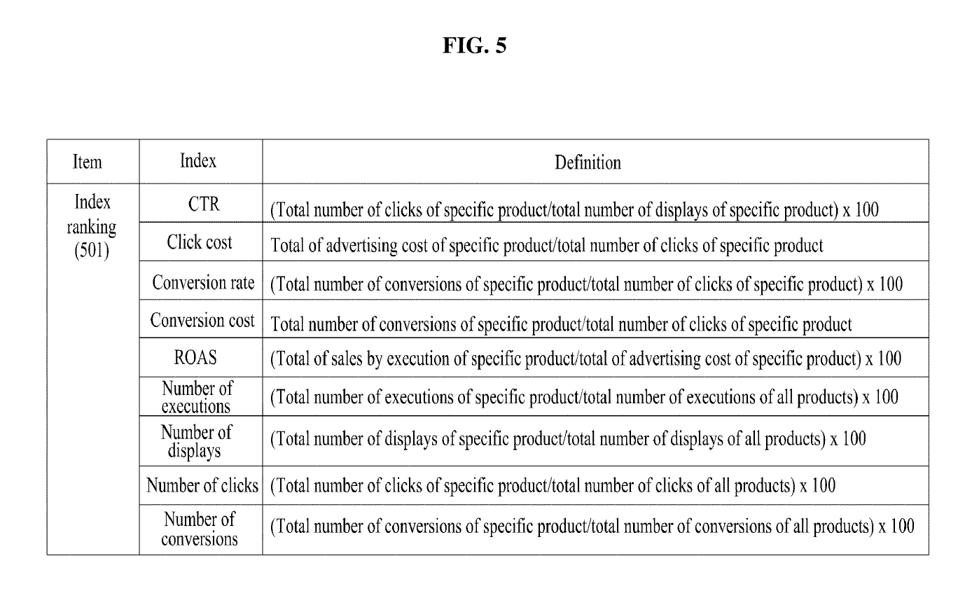

FIG. 5 illustrates a method of generating an index ranking 501. The ranking generator 320 may calculate a ranking of an advertising product based on effect analysis data of a corresponding index with respect to each analysis index. For example, the ranking generator 320 may generate efficiency rankings of advertising products for each analysis index by calculating rankings in descending order based on each index, for example, a CTR, click cost, a conversion rate, conversion cost, ROAS, a number of executions, a number of displays, a number of clicks, a number of conversions, etc., with respect to the advertising products. For example, referring to FIG. 5, the ranking generator 320 may calculate an advertising efficiency ranking for each unit index, such as a ranking according to CTR(=(total number of clicks of specific product/total number of displays of specific product)×100), a ranking according to conversion rate(=(total number of conversions of specific product/total number of clicks of specific product)×100), etc., with respect to a specific product.

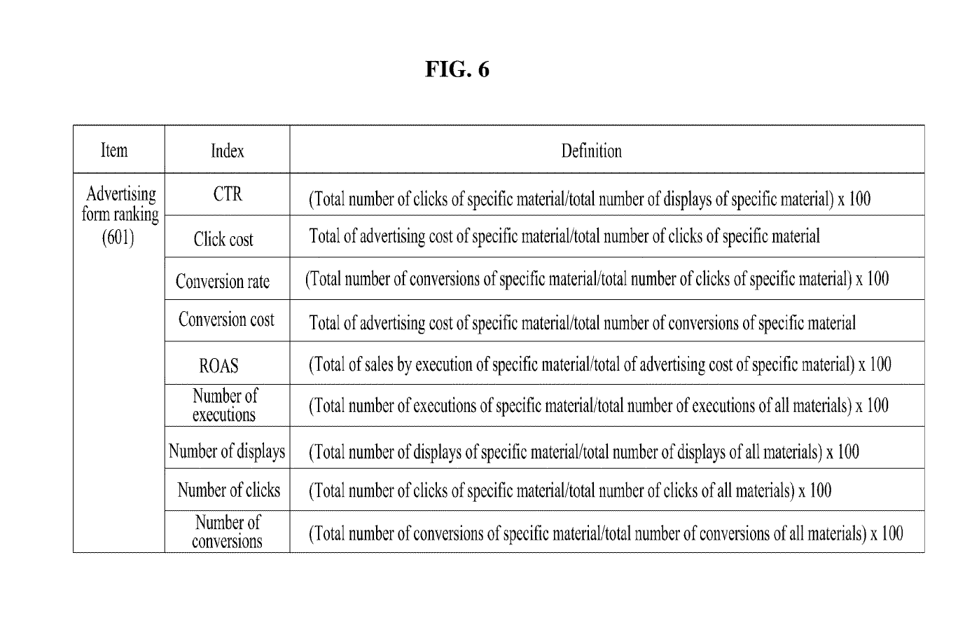

FIG. 6 illustrates a method of generating a advertising format ranking 601. An advertising product may be classified based on a advertising format used for displaying content, for example, search advertising, banner advertising, moving picture advertising, content advertising, and the like. The ranking generator 320 may generate ranking information associated with a advertising format for classifying an advertising product. Referring to FIG. 6, the ranking generator 320 may calculate a ranking of a corresponding advertising form by collecting an effect analysis result of each analysis index with respect to an advertising product corresponding to a specific advertising form. For example, the ranking generator 320 may determine a ranking based on an average value acquired by averaging effect analysis data corresponding to a CTR, click cost, a conversion rate, conversion cost, and ROAS with respect to a specific advertising form, or may determine a ranking based on a proportion of a corresponding advertising form to a total of a number of executions, a number of displays, a number of clicks, and a number of conversions.

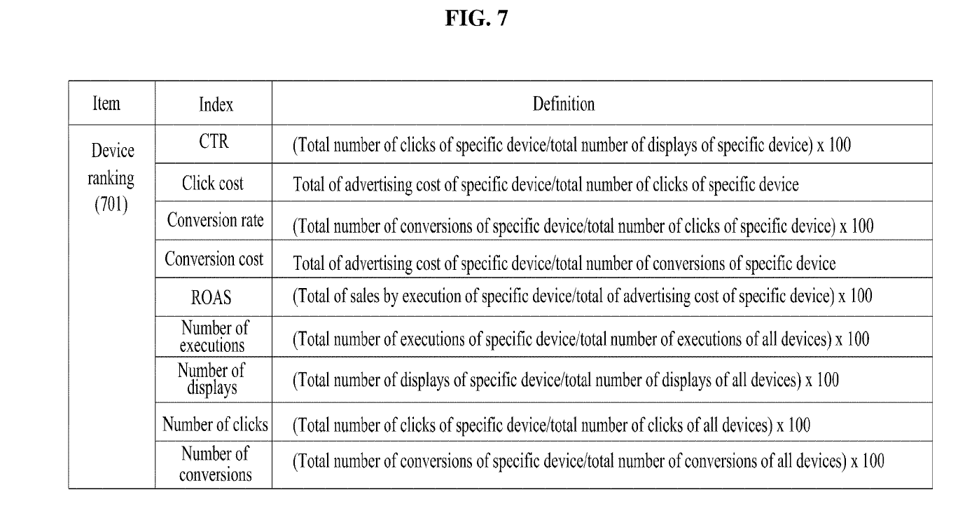

FIG. 7 illustrates a method of generating a device ranking 701. There may be contents to be displayed in a PC environment and contents to be displayed in a mobile environment. An advertising product may be classified based on a content display device. Accordingly, an advertising effect may be analyzed by identifying a device used for content display and ranking information thereof may be generated. The ranking generator 320 may generate ranking information about a content display device. Referring to FIG. 7, the ranking generator 320 may calculate a ranking of a corresponding device by collecting an effect analysis result for each analysis index with respect to a specific device. For example, the ranking generator 320 may determine a ranking based on an average value acquired by averaging effect analysis data corresponding to a CTR, click cost, a conversion rate, conversion cost, and ROAS with respect to a specific device, or may determine a ranking based on a proportion of a corresponding device to a total of a number of executions, a number of displays, a number of clicks, and a number of conversions.

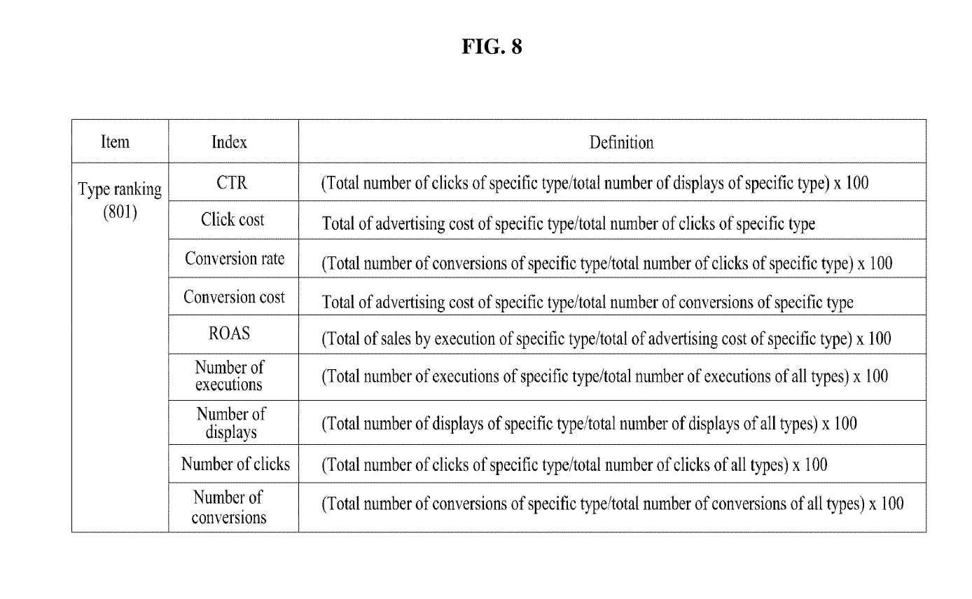

FIG. 8 illustrates a method of generating a type ranking 801. An advertising product may be classified based on a content display type, for example, a shopping advertising scheme, a reward advertising scheme, a retargeting advertising scheme, an app-marketing advertising scheme, a native advertising scheme, and the like. Accordingly, an advertising effect may be analyzed by identifying the content display type and ranking information thereof may be generated. The ranking generator 320 may generate ranking information about a type for classifying an advertising product. Referring to FIG. 8, the ranking generator 320 may calculate a ranking of a corresponding type by collecting an effect analysis result of each analysis index with respect to an advertising product corresponding to a specific type. For example, the ranking generator 320 may determine a ranking based on an average value acquired by averaging effect analysis data corresponding to a CTR, click cost, a conversion rate, conversion cost, and ROAS with respect to a specific type, or may determine a ranking based on a proportion of a corresponding type to a total of a number of executions, a number of displays, a number of clicks, and a number of conversions.

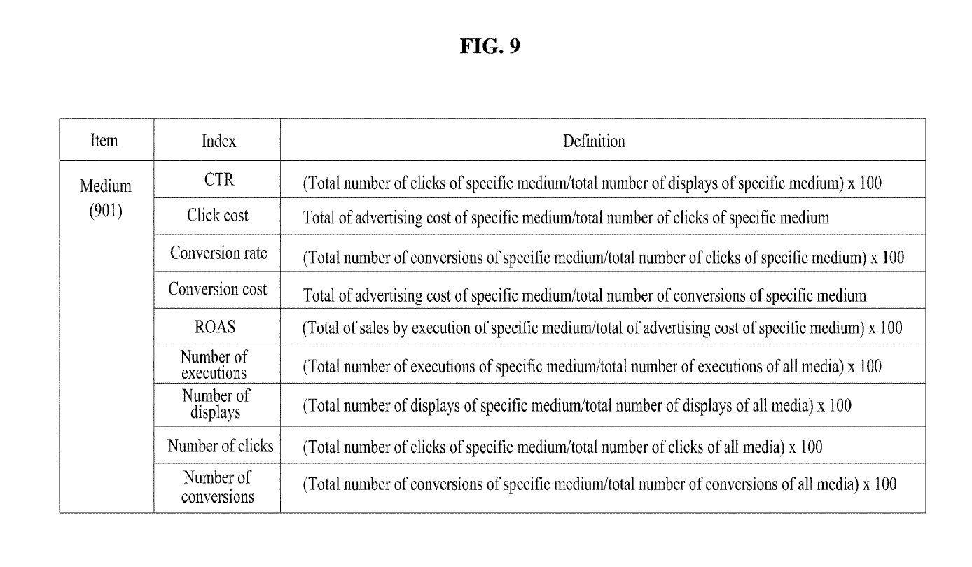

FIG. 9 illustrates a method of generating a medium ranking 901. Content may be displayed through a variety of advertising media, for example, a site, etc., and an advertising product may be classified based on media. Accordingly, an advertising effect may be analyzed by identifying a medium used for content display and ranking information thereof may be generated. The ranking generator 320 may generate ranking information about content display media. Referring to FIG. 9, the ranking generator 320 may calculate a ranking of a corresponding medium by collecting an effect analysis result of each analysis index at a specific medium. For example, the ranking generator 320 may determine a ranking based on an average value acquired by averaging effect analysis data corresponding to a CTR, click cost, a conversion rate, conversion cost, and ROAS with respect to a specific medium, or may determine a ranking based on a proportion of a corresponding medium to a total of a number of executions, a number of displays, a number of clicks, and a number of conversions.

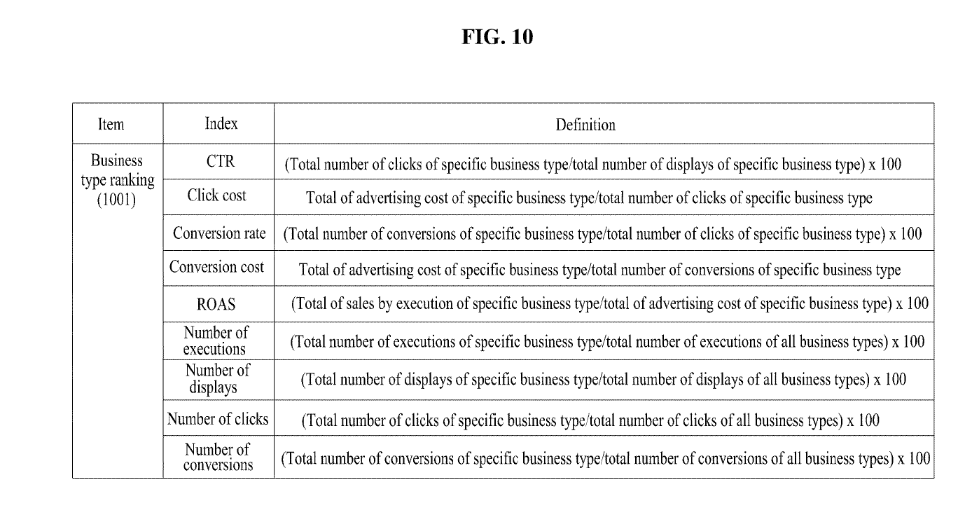

FIG. 10 illustrates a method of generating a business type ranking 1001. An advertiser or content provided from the advertiser may be classified based on a type of business or a category and an advertising product may be classified based on a type of business. Accordingly, an advertising effect may be analyzed by identifying a type of business and ranking information thereof may be generated. The ranking generator 320 may generate ranking information about a type of business used to classify an advertiser or content. Referring to FIG. 10, the ranking generator 320 may calculate a ranking of a corresponding type of business by collecting an effect analysis result of each analysis index with respect to a specific type of business. For example, the ranking generator 320 may determine a ranking based on an average value acquired by averaging effect analysis data corresponding to a CTR, click cost, a conversion rate, conversion cost, and ROAS with respect to a specific type of business, or may determine a ranking based on a proportion of a corresponding type of business to a total of a number of executions, a number of displays, a number of clicks, and a number of conversions.

In addition to a type of business, a content display area within a site may be classified into a variety of collections, for example, news, a blog, a moving picture, café, etc. Ranking information of a corresponding collection may be generated by analyzing an advertising effect of each collection.

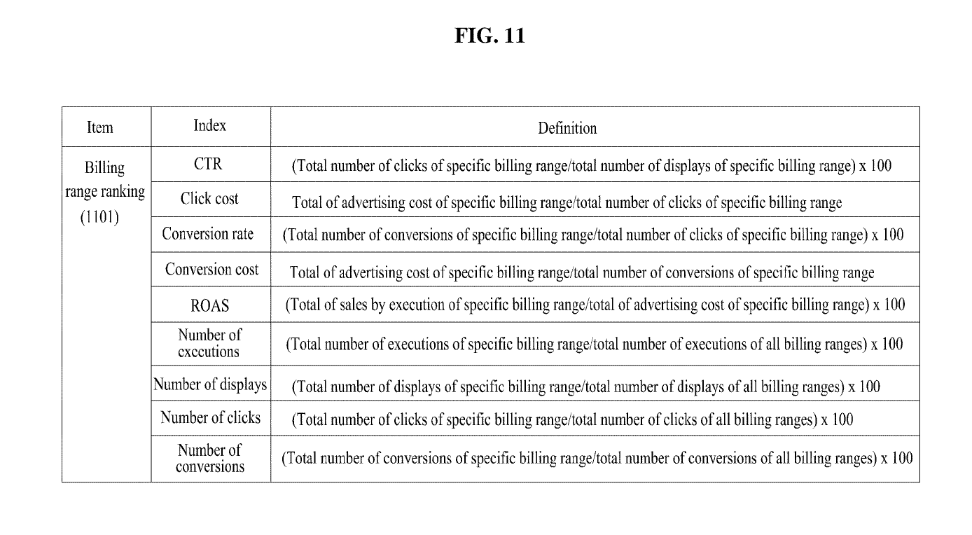

FIG. 11 illustrates a method of generating a billing range ranking 1101. A billing range may be set as advertising cost for advertising execution by an advertiser, and an advertising product may be classified based on the billing range. Accordingly, an advertising effect may be analyzed based on a corresponding billing range by identifying the billing range and ranking information thereof may be generated. The ranking generator 320 may generate ranking information about a billing range of advertising execution. Referring to FIG. 11, the ranking generator 320 may calculate a ranking of a corresponding billing range by collecting an effect analysis result of each analysis index with respect to a specific billing range. For example, the ranking generator 320 may generate a ranking based on an average value acquired by averaging effect analysis data corresponding to a CTR, click cost, a conversion rate, conversion cost, and ROAS with respect to a specific billing range, or may determine a ranking based on a proportion of a corresponding billing range to a total of a number of executions, a number of displays, a number of clicks, and a number of conversions.

In addition to the aforementioned items, an advertising effect of each keyword that is used as an advertising influx path may be generated and ranking information of a keyword may be generated. For example, the effect analyzer 310 may analyze an advertising effect of a keyword based on keyword-related analysis indices, for example, a number of user influxes, a number of conversions, a number of direct conversions, a number of indirect conversions, a conversion rate, an average stay time, a return rate, and the like. Here, the number of user influxes is an index indicating a number of times that an influx occurs through a search using a specific keyword, the number of conversions is an index indicating a number of times that a conversion occurs through a search using the specific keyword, the number of direct conversions is an index indicating a number of times that a direct conversion occurs after influx using the specific keyword, and the number of indirect conversions is an index indicating a number of times that a conversion occurs through a re-influx using another keyword after an influx using the specific keyword. The conversion rate is an index indicating a rate at which a conversion to a purchase, a membership signup, etc., occurs after search and visit using the specific keyword, the average stay time is an index indicating an average amount of time in which users visit and stay using the specific keyword, and the return rate is an index indicating a return rate after conducting a search using the specific keyword and visit. Accordingly, the ranking generator 320 may generate ranking information of a keyword based on an effect analysis result of the keyword that is used as an influx path.

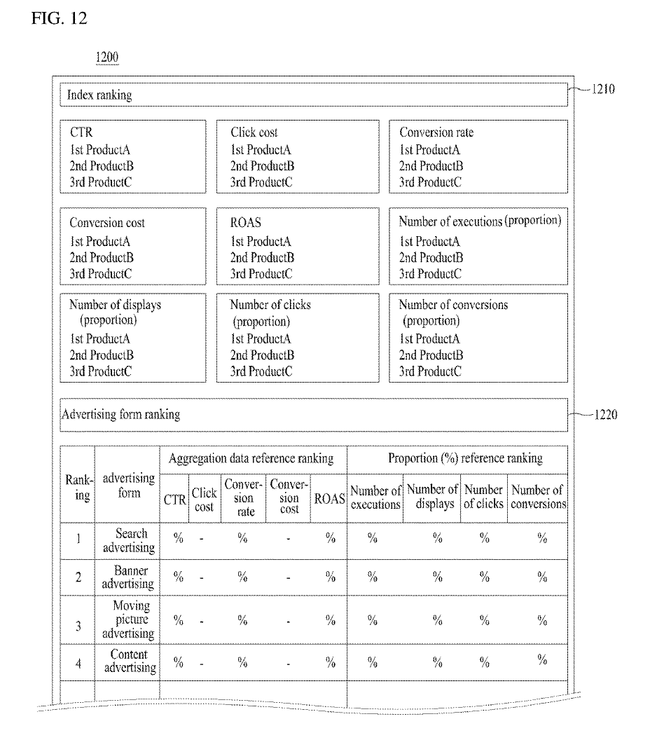

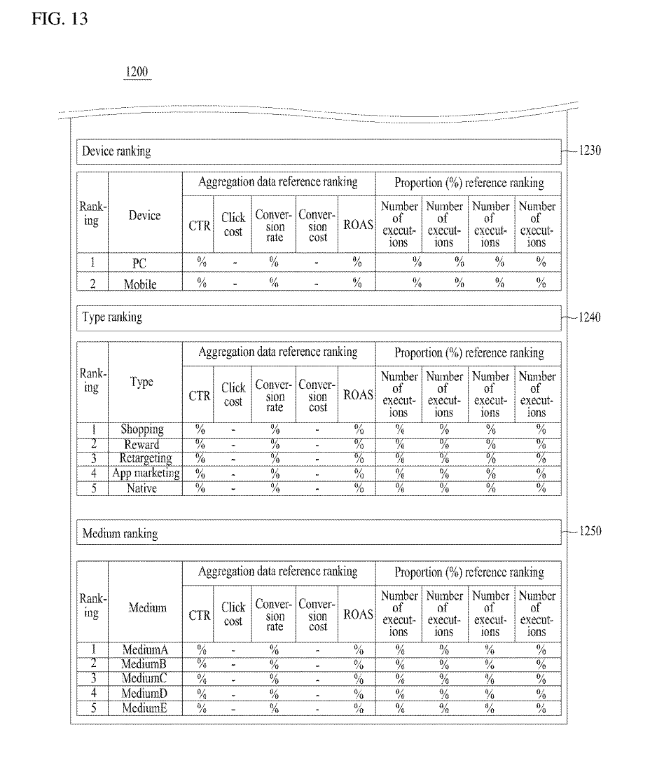

FIGS. 12 and 13 illustrate a service screen 1200 for providing ranking information for each item that is an effect analysis target, according to exemplary embodiments. Referring to FIG. 12, the service screen 1200 may include an index ranking 1210 that provides efficiency rankings of advertising products based on each analysis index, for example, a CTR, click cost, a conversion rate, conversion cost, ROAS, a number of executions, a number of displays, a number of clicks, and a number of conversions, and a advertising format ranking 1220 that provides efficiency rankings of advertising format, for example, search advertising, banner advertising, moving picture advertising, and content advertising. In addition, referring to FIG. 13, the service screen 1200 may include a device ranking 1230 that provides efficiency rankings of devices, for example, a PC and a mobile, a type ranking 1240 that provides efficiency rankings of advertising types, for example, shopping, reward, retargeting, app marketing, and native, and a medium ranking 1250 that provides efficiency rankings of advertising display media. In addition to the aforementioned rankings, the service screen 1200 may further include ranking information that provides efficiency rankings of business types, collections, billing ranges, keywords, and the like.

Ranking information may be displayed on the service screen 1200 in a list form in which rankings are sorted in descending order, or may be displayed in a form of various types of graphs, for example, a bar graph and a line graph. Also, the service screen 1200 may display a user interface (UI) for designating an effect analysis period, for example, a previous month, previous three months, and previous six months, for providing advertising efficiency rankings.

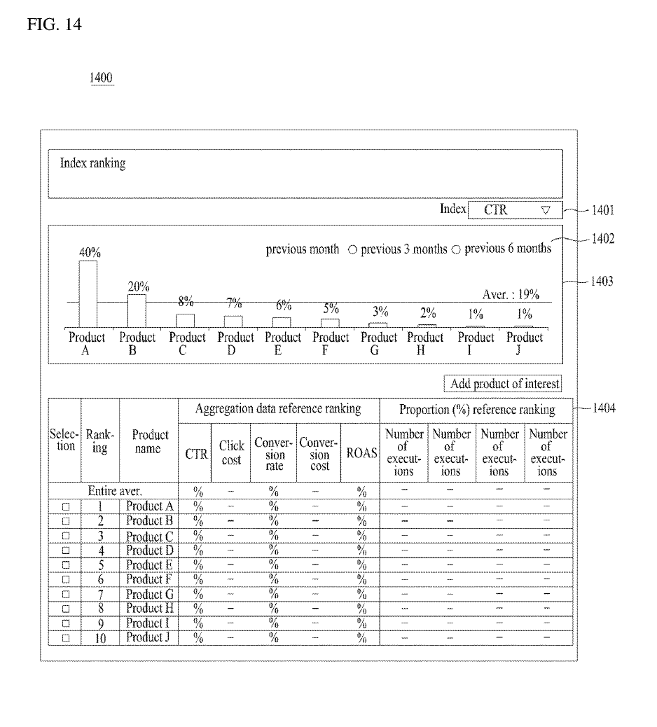

The service screen 1200 shown in FIGS. 12 and 13 may be configured to display top rankings by default, and may be directed to a lower screen including detailed ranking information in response to a selection on a specific ranking on the corresponding screen. For example, in response to a selection on the index ranking 1210 displayed on the service screen 1200 of FIG. 12, the user may be directed to a detailed ranking screen 1400 of FIG. 14. The detailed ranking screen 1400 may include an index selection UI 1401 for selecting an analysis index, a UI 1402 for designating an effect analysis period, a ranking graph 1403 for showing rankings of advertising products based on the selected index, a ranking table 1404 for listing and thereby displaying rankings of advertising products based on the selected index, and the like. The detailed ranking screen 1400 may further include a UI for selecting at least one advertising product from among advertising products included in the ranking table 1404, and the like.

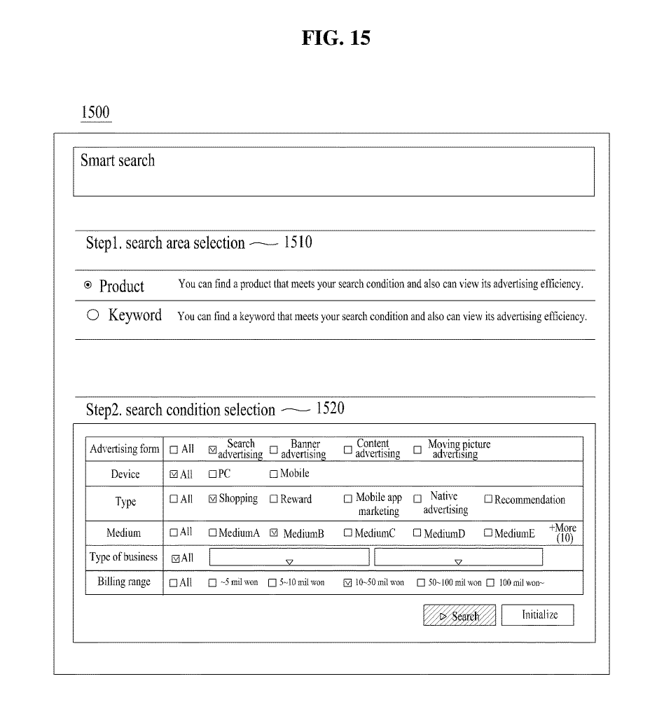

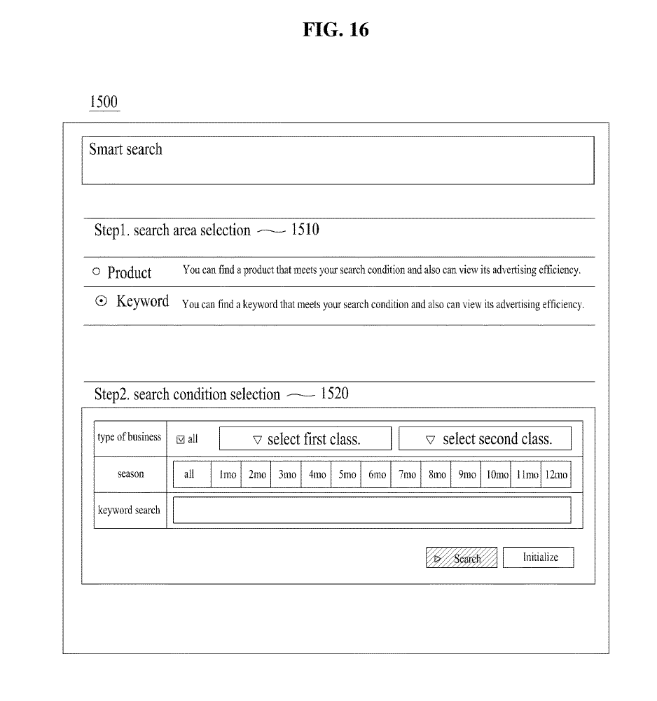

FIGS. 15 and 16 illustrate examples of an advertising efficiency search screen 1500. For example, the advertising efficiency search screen 1500 may include a search area selection menu 1510 for selecting a search area, a search condition selection menu 1520 for selecting a search condition, and the like. The search area selection menu 1510 may include a ‘product’ menu for searching for an advertising product that meets a desired search condition and verifying an advertising efficiency of the corresponding product, a ‘keyword’ menu for searching for a keyword that meets a desired search condition and verifying an advertising efficiency of the corresponding keyword, and the like.

Referring to FIG. 15, the search condition selection menu 1520 for selecting a advertising format, a device, a type, a medium, a type of business, a billing range, etc., with respect to an advertising product to be searched may be provided in response to a selection on the ‘product’ menu on the search area selection menu 1510. An effect analysis result and ranking information of the advertising product corresponding to the search condition through the search condition selection menu 1520 may be displayed as a search result on the advertising efficiency search screen 1500. Accordingly, the user may refer to advertising products that meet the desired search condition and may verify advertising efficiency and ranking of each of the products.

Referring to FIG. 16, the search condition selection menu 1520 for inputting a keyword as a search condition may be displayed in response to a selection on the ‘keyword’ menu on the search area selection menu 1510. The search condition selection menu 1520 may include a menu for additional input or selection, such as a type of business, an effect analysis type (season), etc., as the search condition of the keyword. An effect analysis result and ranking information of the keyword input through the search condition selection menu 1520 may be displayed as the search result on the advertising efficiency search screen 1500. Accordingly, the user may refer to a keyword that the user is interested and may verify an advertising efficiency and a ranking of the keyword.

The ranking information included in the search result may be displayed in a form of a list sorted based on a criterion, such as descending order, or may be displayed in a form of various graphs, such as a bar graph and a line graph, on the advertising efficiency search screen 1500. Further, the advertising efficiency search screen 1500 may further include a UI for selecting at least one specific product or specific keyword from among advertising products or keywords included in the search result and registering the selected product or keyword as a target of interest.

According to exemplary embodiments, it is possible to provide effect analysis results and ranking information of various items that are effect analysis targets with respect to a user that participates in an advertising operation, and to provide a search environment in which the user may select a desired search area and search condition, and may refer to an advertising efficiency of a desired target in person.

According to exemplary embodiments, it is possible to provide a wide selection of objective data for an advertising operation by providing ranking information about various items, for example, an index, an advertising format, a device, an advertising type, a medium, a type of business, a billing range, an user influx source, a keyword, and the like, based on effect analysis data about an advertising product. Also, according to exemplary embodiments, it is possible to provide an advertising operation solution suitable and specified for an advertiser request by providing an advertiser with a search environment associated with an advertising product, a keyword, and the like, and by providing detailed effect analysis data and ranking information associated with a search target using the search environment.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The exemplary embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present disclosure, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method of providing a ranking information of content automatically generated in response to a service request of a user, the method comprising:
analyzing an effect of providing the content based on at least one analysis index to produce an effect analysis result;
generating ranking information about at least one item associated with the content provided based on the effect analysis result; and
providing the ranking information about the at least one item in response to receiving a service request from an electronic device operated by the user.

2. The method of claim 1, wherein the generating ranking information comprises calculating a ranking of a corresponding item based on an effect analysis result of a corresponding index with respect to each analysis index.

3. The method of claim 1, wherein the generating ranking information comprises calculating a ranking of a corresponding item based on an average effect analysis result of analysis indices with respect to each item.

4. The method of claim 1, wherein the generating ranking information comprises calculating a ranking of a corresponding item based on a ratio of the item to a total of effect analysis results of analysis indices with respect to each item.

5. The method of claim 1, wherein the generating ranking information comprises generating the ranking information for each of at least one item of a advertising format, a device, a type, a medium, a type of business, cost, and a keyword that are associated with displaying of the content based on the effect analysis result.

6. The method of claim 1, wherein the analyzing the effect comprises collecting and aggregating effect analysis data corresponding to providing of the content through an external server or medium.

7. The method of claim 1, wherein the providing the ranking information comprises providing ranking information of an item corresponding to a search condition in response to receiving the search condition from the electronic device.

8. The method of claim 1, wherein the providing the ranking information comprises providing ranking information of a keyword or ranking information of an item corresponding to the keyword in response to receiving an input of the keyword as a search condition from the electronic device.

9. The method of claim 1, further comprising:
registering a specific item as a target of interest associated with a user of the electronic device in response to a selection on the specific item among items included in the ranking information through the electronic device.

10. The method of claim 9, further comprising:
providing at least one of items registered as the target of interest as an execution condition for providing content associated with the user.

11. A non-transitory computer-readable storage medium storing instructions that, when executed by a processor, cause the processor to perform a method of providing a ranking information of content automatically generated in response to a service request of a user, the method comprising:
analyzing an effect of providing the content based on at least one analysis index to produce an effect analysis result;
generating ranking information about at least one item associated with the content provided based on the effect analysis result; and
providing the ranking information about the at least one item in response to receiving a service request from an electronic device operated by the user.

12. A ranking information providing system configured to automatically generate a ranking information of content in response to a service request of a user, the ranking information providing system comprising:
an effect analyzer configured to analyze an effect corresponding to providing of content based on at least one analysis index to produce an effect analysis result;
a ranking generator configured to generate ranking information about at least one item associated with providing of the content based on the effect analysis result; and
a ranking provider configured to provide the ranking information about the at least one item in response to receiving a service request from an electronic device.

13. The ranking information providing system of claim 12, wherein the ranking generator is configured to calculate a ranking of a corresponding item based on an effect analysis result of a corresponding index with respect to each analysis index.

14. The ranking information providing system of claim 12, wherein the ranking generator is configured to calculate a ranking of a corresponding item based on an average effect analysis result of analysis indices with respect to each item.

15. The ranking information providing system of claim 12, wherein the ranking generator is configured to calculate a ranking of a corresponding item based on a ratio of the item to a total of effect analysis results of analysis indices with respect to each item.

16. The ranking information providing system of claim 12, wherein the ranking generator is configured to generate the ranking information for each of at least one item of a advertising format, a device, a type, a medium, a type of business, cost, and a keyword that are associated with displaying of the content based on the effect analysis result.

17. The ranking information providing system of claim 12, wherein the ranking provider is configured to provide ranking information of an item corresponding to a search condition in response to receiving the search condition from the electronic device.

18. The ranking information providing system of claim 12, wherein the ranking provider is configured to provide ranking information of a keyword or ranking information of an item corresponding to the keyword in response to receiving an input of the keyword as a search condition from the electronic device.

19. The ranking information providing system of claim 12, further comprising:
an information manager configured to register a specific item as a target of interest associated with a user of the electronic device in response to a selection on the specific item among items included in the ranking information through the electronic device.

20. The ranking information providing system of claim 19, further comprising:
a content provider configured to provide at least one of items registered as the target of interest as an execution condition for providing content associated with the user.
